(19) United States
(12) Patent Application Publication
(10) Pub. No.: US 2007/0266371 A1
(43) Pub. Date: Nov. 15, 2007

(54) MULTIPLE CORRECTION REQUESTS OCCURRING FROM A SINGLE REQUEST

(76) Inventor: Suraj RAMAKRISHNAN, Calcutta (IN)

Correspondence Address: KENYON & KENYON LLP, 1500 K STREET N.W., WASHINGTON, DC, 20005, US

(21) Appl. No.: 11/618,778

(22) Filed: Dec. 30, 2006

(30) Foreign Application Priority Data
Dec. 30, 2005 (IN) 24/DEL/2006

(51) Int. Cl. G06F 9/44

(52) U.S. Cl. 717/121

(57) ABSTRACT

A method and system for change tracking is provided. The tracking method and system may contain a table which includes data describing changes made on a specific version of a product or system. The table is accessed by a method or system to automatically provide a user of a specific version of a product or system with an option to change a software component (or module) in the specific version and in related versions. The relationship between the specific version and related version, as well as the appropriate change, is predetermined and stored for later accessibility such as when, for example, confronted with the same or similar situation.

### FIELD OF THE INVENTION

The present invention generally relates to computer workflows and, more specifically, to change tracking.

### BACKGROUND

Many repetitive tasks within a system can be performed automatically to increase a user's efficiency. A change tracking system is a system in which a user can track a proposed change to a problem throughout its life cycle. At each stage of the task, the proposed change is addressed by the particular user, marked, and sent off to the next stage for further processing. A sample change tracking system may be a system that tracks customer service problems. A customer service representative may create a new proposed change for each caller he receives. If he successfully addresses the caller's questions, the representative may mark the change as resolved If not, the representative may assign the task to a second level representative for further processing.

Change tracking systems are available, but they tack the intelligence to automatically group related entities together. For example, software companies release multiple versions of a given product that all share common components. Testing may reveal a bug in one common software component. That bug may be addressed in each version by manually issuing a separate change request, or correction request, for each version. This means, each user of any version must receive, for example, a separate patch for each version maintained on its system, as provided for by the software company/software support system, and tediously apply each separate patch to each version. Or, the software company I software support system may provide a user with one patch applicable to one version of the software in order to address a reported bug by the user. This would not solve similar software error/bug issues in other versions of the software—or other common components of a software package or the like, Further, the user may attempt to apply the same patch manually to at least another version of the same software—and in so doing, the user may create additional bugs in its other version(s). Today, change tracking systems require a developer to generate a number of similar changes, one for each different component and/or software version, even if each change may contain nearly all the same information. Creating a number of nearly identical changes wastes both the developer's and the user's time. A need exists for a change tracking system that allows related changes to be automatically created and implemented.

### BRIEF DESCRIPTION OF THE DRAWINGS

FIG. 1 illustrates an exemplary method of the present invention.

FIG. 2 illustrates an exemplary method according to FIG. 1 of the present invention.

FIG. 3 illustrates a block diagram of an embodiment of the present invention.

FIG. 4A illustrates a dataflow diagram of an embodiment of the present invention.

FIG. 4B illustrates a dataflow diagram of an embodiment of the present invention,

FIG. 5 illustrates an exemplary table according to an embodiment of the present invention.

### DETAILED DESCRIPTION

Embodiments of the present invention work cooperatively with existing computer network systems to provide a method and/or system in which a change made to a specific version of a component or system is memorialized and associated with all appropriate versions of the component or system. Such memorializations and associations are described in exemplary embodiments herein. Thus, when a future user is prompted with an option to make the same or similar change to a specific version: the user also may be prompted with an option to make the change to earlier and later versions of the same or related component or system. Such a change may be, for example, a correction request to fix a bug reported by a customer. Or, the change may be, for example, an improvement of the product/system. Such improvements to the product/system may include for example: an increase in processing time, a reduction in redundant code, or other desirable improvements,

Further embodiments of the present invention provide a method and/or system for tracking changes and creating additional changes pertaining to a component or system. When a change is identified: it is then memorialized, for example, in a table. Thereafter, the change may be identified to a testing entity which tests to confirm that the change is appropriate for the component or system. The testing entity may also conduct tests to confirm that the same change is appropriate for related components or related systems. For example, the testing entity may obtain information from a backend system, from manual input, or other, which identifies related versions of the components or systems. The results obtained by the testing entity may then be memorialized for future use. For example, the test results of the specific change, analyzing compatibility with the version in use as well as the related versions of the components or systems, may be added to the same table or database as the change and the first version tested. Thus, when a user uses one of the versions, a pop-up window, or other interface, may interrupt the user and provide an opportunity to make the specific change to the version in use, and to earlier and/or later versions or related components or systems.

The results obtained by the testing entity regarding the change may be memorialized in a change tracking table which may be populated with various pieces of information, including which other software or hardware components are related to the program in which the bug/error was encountered. The associations between the various components may be manually inputted by the developer or some other individual, or may be automatically determined by the system. The next time a user encounters another bug/error in one of the components referenced in the change tracking table, the system may prompt the user as to whether he wishes for the error to be corrected in all related versions of the component. The system may determine the relations between the different components from the information which was already entered in the change tracking table.

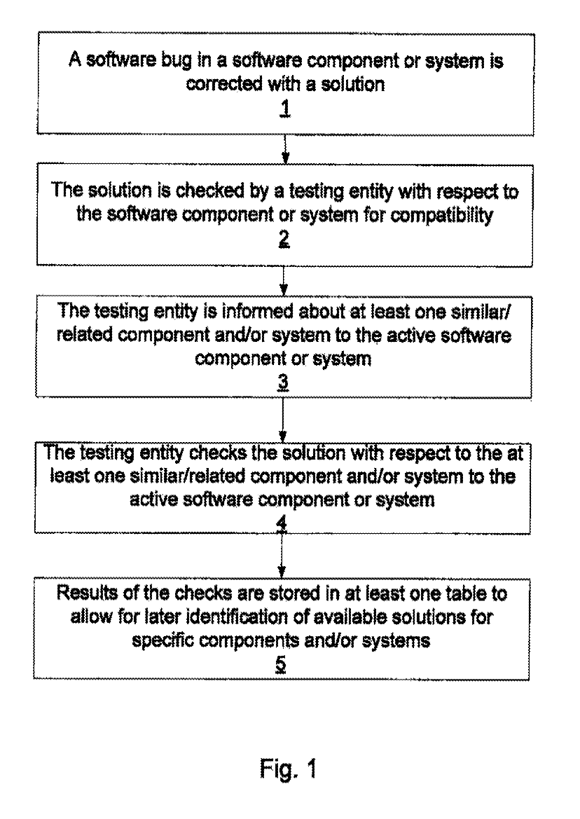

FIG. 1 illustrates an exemplary method of the present invention. In the situation where a customer finds a bug or error in a software program, a customer may contact, for example, a software support system to correct the error. The customer informs the software support system representative about the software version and the error found. The representative then may recreate the error in the same software version and prepare a solution to the error 1. Thereafter, the representative may forward the information to a testing entity which tests the compatibility of the solution with the software version 2 Such testing can assist in confirming that the solution is compatible with the software version and does not cause any undesired side effects, such as errors/bugs. The testing entity may then be informed about additional software versions or related components which may benefit from the solution 3. The testing entity may be informed about the other versions or related components, for example, by a backend computer system automatically, by the representative, or by requesting the information from a lookup table. The testing entity then may check the compatibility of the same solution with the other versions or related components 4. The results of the checks may then be deposited in a manner so that the results are linked. For example, a description of the error solved, the solution, the compatibility results, and the respective software versions or components, may be located in a table or database 5. Note, the representative and/or the testing entity may be skilled persons, or machines automated to conduct such events.

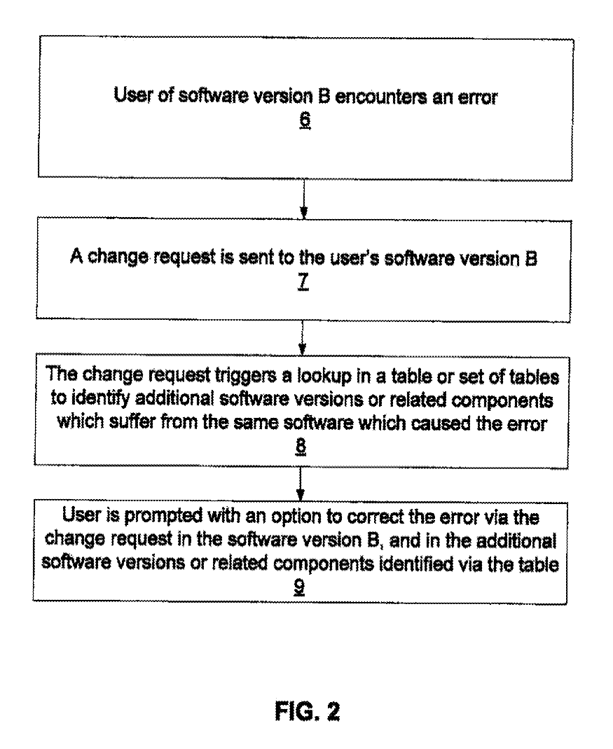

FIG. 2 illustrates a further exemplary method of the present invention wherein the table described, e.g., in FIG. 1, has already been established. When a user of a software, for example, software version B, encounters an error 6, and contacts, for example, the software support system, the software support system representative first checks the table or tables of changes to determine if the same error has been encountered and solved. If the same error has been resolved for the same software version B, then a change request (i.e., a command to change a certain segment of code) is sent by the developer to the user's software version 8 to resolve the error 7. This change request triggers a prompt to ask one of the representative and/or the user whether related components or systems should be corrected 8. For example, the table may include information that software version B has an earlier software version A and a later software version C, and that those software versions are compatible with the solution. Then, the developer or user may be prompted by an interface requesting whether the same error or change should be resolved in each of software versions A, B, and/or C 9.

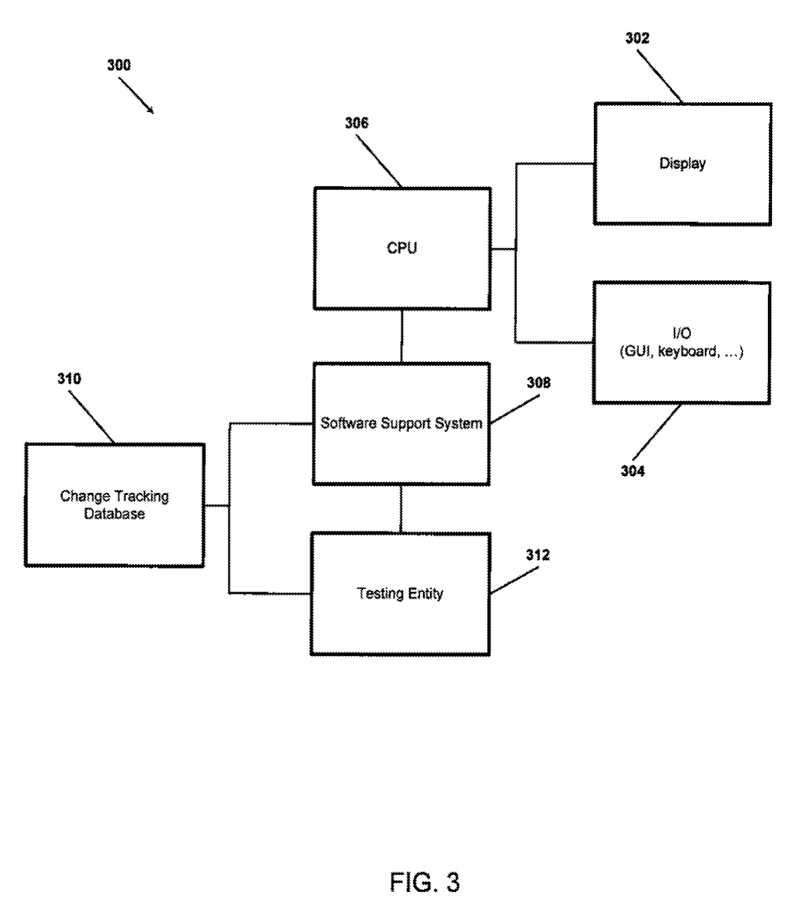

FIG. 3 illustrates a simplified block diagram of an exemplary computer system 300 suitable for use with the present invention. The user encounters an error in a software program or component installed on CPU 306. The user may then contact, e.g., a software support system 308 to correct the error. This contact may be in the form of a request generated by the CPU 306, and may reference the software version in use and the error encountered. After the CPU 306 generates the request, it may pass it onto the software support system 308. The first time the present invention is employed, the software support system 308 may initially create a change tracking database 310. If this is not the first time the present invention is employed, the software support system 308 may check the change tracking database 310 to determine whether the same error has been encountered and solved previously. If the same error has been resolved for the same software version, a change request, consisting of a solution to the software bug, may be sent by software support system 308 to the user's software version to resolve the error. This change request may trigger a prompt to ask the user, via the display 302, whether related components or systems should be corrected. For example, suppose the change tracking database 310 includes information that software version Y has an earlier software version X and a later software version Z, and that those software versions are compatible with the solution. Then, the user may be prompted by a display 302, requesting whether the same error or change should be resolved in each of software versions X, Y, and/or Z. Alternative embodiments of the present invention may automatically create changes in the various versions and/or common components without the users being prompted,

Alternatively, if the same error has not been resolved for the same software version, the software support system 308 may recreate the error in the same software version and prepare a solution to the error. The software support system 308 then may forward the solution, a reference to the software version in use, and a description of the bug, to a testing entity 312 which tests the compatibility of the solution with the software version. A representative of the software support system 308 may also conduct the testing. The testing entity 312 or representative of the software support system 308 may determine whether additional software versions or related components may benefit from the solution. The testing entity 312 or a representative of the software support system 308 may be informed about the other versions or related components, for example, by a backend computer system automatically., by the software support system 308: by requesting the information from a lookup table, or from the change tracking database 310. If this is the first time the present invention is employed, this information could not be retrieved from the change tracking database 310 because it would be unpopulated at this point. The testing entity 312 or a representative of the software support system 308 may then check the compatibility of the same solution with the other versions or related components. The results of the checks may then be saved in the change tracking database 310 in a manner so that the results are linked. For example, a description of the error solved, the solution, the compatibility results, and the respective software versions or components,, may be located in change tracking database 310. Note, the software support system 308 and/or the testing entity 312 may be skilled persons, or, in fact, machines automated to conduct such events.

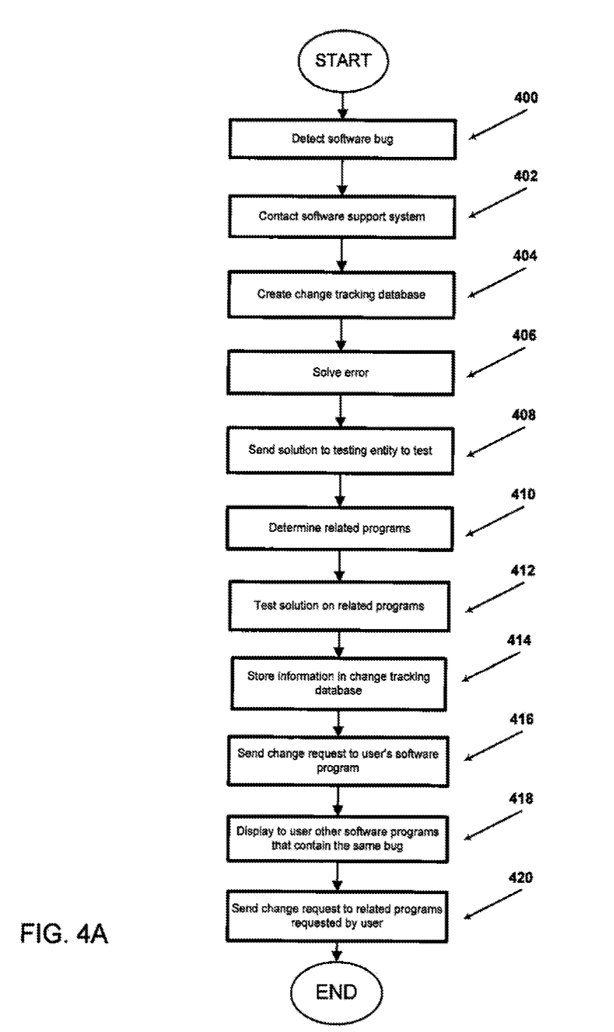

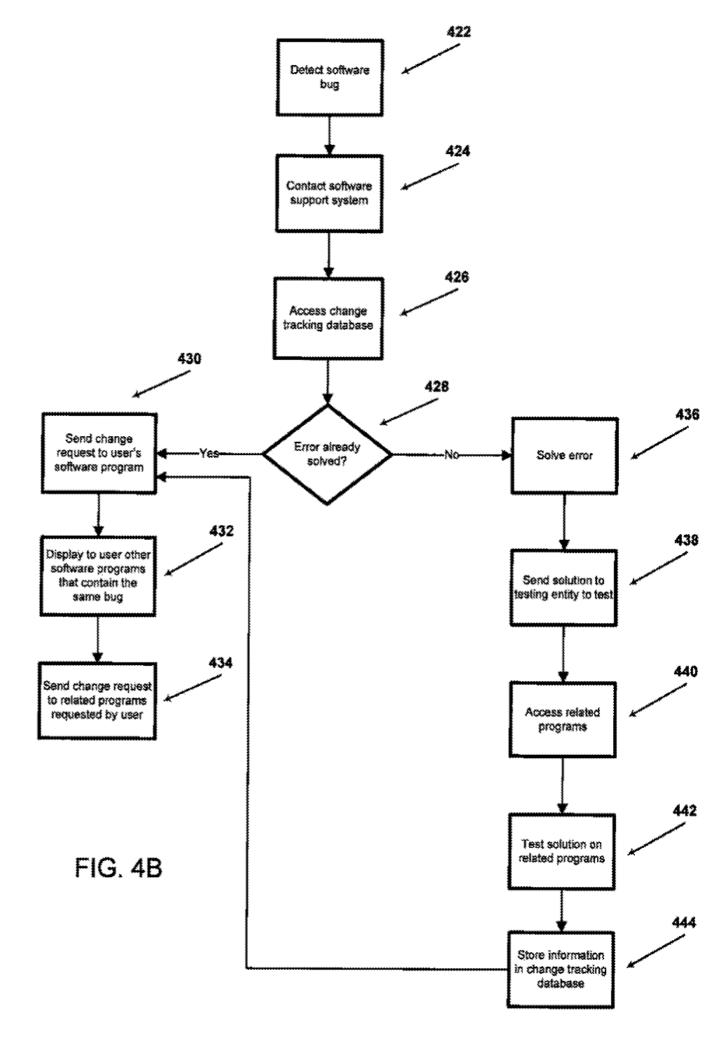

FIG. 4A illustrates an embodiment of the present invention. This embodiment of the present invention illustrates operation of the invention the first time that the invention operates. When a user of a software product encounters an error 400 the user may contact the associated software support system, e.g. the manufacturer of the software product, for assistance 402. Upon contact, the user informs the software support developer about the specific software product version being used and the error encountered. Note that this contact between the software support system and the user may occur at the specific request and action of the user, or it may occur automatically by the user's CPU in response to the existence or finding of an error. The software support developer may then recreate the error in the same version on its own computer system in order to develop a solution to resolve the error. Upon resolution of the error 406: the solution may be sent to a testing developer 408 who may check the software product with the new solution via, e g., a standard battery d tests. This sending of the solution to the testing developer, or, e.g., automated testing system, may occur automatically upon completion of the development of a solution or it may be a manual send by the support developer or another. The solution is tested to confirm that it is compatible with the software component it serves as well as the software product it belongs to, since, e.g., the solution may operate correctly in the software component but may create errors in the overall software product. Upon successful testing, the software support developer may receive notification from the testing developer, and a patch including a change request or correction request, may be prepared and/or sent to the user originally requesting a solution 416. In addition, the patch may also be sent to all other customers of that same version so that they do not later encounter the same error.

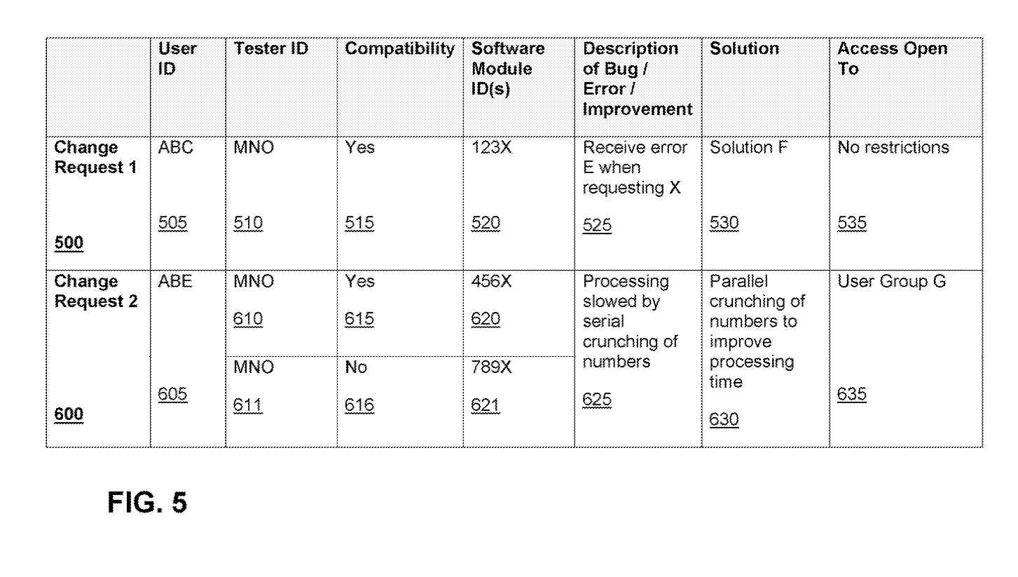

At any time during this process, the software support developer may create a change tracking database 404 in which to store the records relating to each change made from that point on to software product(s) or to components or modules of a software product. For example, the software support developer may create this database manually, as information becomes available, or the system may automatically create the database at the first instance of an error being reported. The records may be stored, for example, in a table, such as that illustrated in FIG. 5. The database may be populated manually by the software developer or another individual, or it may be populated automatically by the backend system of the software company. For example, a record of a solved error may include such information as the User ID of the user entering the record, the Tester ID of the testing developer who tested the solution, the testing result (e.g., successful, not successful), the software module and/or version of the software program in which the error occurred, any software modules or components that are related to the module in which the error occurred, a description of the error, a solution to the error, and any access restrictions to the solution. The information concerning related software modules and/or versions of a software product may be information that the developer manually inputs into the database 410. For any given software product, the support system developers may be updated or may request information concerning upcoming related products and/or versions. As the software developer, or other company representative, learns of related software products, this information can be entered into the same change tracking database. For example, when a developer creates a solution A to bug B for a user, the developer may then create a database which stores a record of that information, along with any information the developer knows about related products which will necessarily contain that bug B. Such related products may be upcoming and as-yet unreleased versions of the same software product originally having bug B. This information may be internal information, only inside the software company at the time. For example, the change tracking database may be solely for the developer's use.

The related modules or products may also be determined by a lookup table stored on the system. A software company may create a software product version database or a related products database on its system for easy access to the information by developers. A simple fetch action may be used to obtain information regarding related products for the purpose of the tracking change database,

Once the related versions or modules are determined, e.g., by the support developer or by the system informing the developer about related software programs/modules that necessarily may contain the same error 418 the testing developer may then test the same solution to correct error B in each of the related software programs/modules 412. The testing developer may find, e.g., that upcoming versions 6 and 7 do not contain the specific module or at least not error B but that earlier versions 2 and 3 do. Further, the testing developer may find that, e.g., the solution to the error B is not compatible with the earlier version 3 software. The results of all of such tests performed by the testing developer on the related versions may be stored in the change tracking database 414. In addition, if the related versions are available, the developer may send a change request to those related programs, or specify that the specific patch must be sent with the related program when implemented at a user's location 420.

FIG. 4B illustrates a further embodiment of the present invention. In FIG. 4B, it is assumed that the change tracking database has been created as shown, e.g., in FIG. 4A. In FIG. 4B, a user C encounters an error D 422 in, e.g., the same software product as in FIG. 4A 422. User C may then contact the software support system for assistance to correct the error D 424. Error D may be the same or may be a different error than the error B referenced in the example described in FIG. 4A. Of course, it is likely that user C already had the update or patch which resolved error B implemented in its software product. User C must supply the support system with the software product and version information, as well as a description of the error D. Upon receiving the request, the support developer or system may resolve the error 436 and conduct testing of the solution in the program 438, e.g., as described in FIG. 4A. In addition: prior to or after resolving the error, the support developer and/or testing developer may receive a popup window or other graphical user interface which, by accessing the change tracking database 426: advises the developer(s) that the specific software product version also has related versions 440: for example. And, the interface may provide a checklist to the developer(s) asking if it wanted to test the new solution to error D in those related versions 442. This function of the change tracking database provides an efficient working environment for the software developer and the testing developer since they save the time and effort of investigating whether such versions or related modules exist or will exist. Further, if the error D is the same as the previous error B: the graphical user interface informs the developer(s) that a tested solution to similar error B for the same version has been solved and that a patch for the user is available 430. This information can save the developer time by preventing him from having to resolve the same or similar error more than once.

The developer(s) may also update the change tracking database 444 with the error D situation as done in FIG. 4A with error B. Further, while the embodiment of FIG. 4B involves the same versioned product as in FIG. 4A: the change tracking database may be populated with data regarding any software product maintained by the support system, and any errors or bugs encountered. In other embodiments, the change tracking database may include not only a listing of the errors or bugs associated with a particular software product and its related versions, but also may include a listing of all improvements, e.g., improvement of processing time of the product, made via patches or other updates to the software product. In each situation, however, it is useful that the developer(s) continue to record the information about the related products and/or versions in the change tracking database.

In further embodiments, upon contact by a user or the user's CPU, a software support system may automatically access the tracking change database to determine whether the user's encountered error has been corrected. And, if not, then the software support system may forward the request to a support software developer, e.g., via email, for resolution. If the support system finds that the error has been previously resolved, the support system may access the change tracking database to determine the identity or location of the solution, and send the developed patch to the user or the user's CPU or install the solution directly onto the user's CPU if such a connection can be established.

In further embodiments, the graphical user interface accessing the change tracking database may be a popup window with check boxes which asks the developer to click on all related versions/components in a display list for which the developer would like to test and/or implement the solution. Note that the information regarding related versions and components may be obtained from the change tracking database.

FIG. 5 illustrates an exemplary table that may be used as the change tracking database in embodiments of the present invention. For example, in the table, Change Request 1 500 is associated with the description of the bug/error/improvement that it was designed to correct and with the corresponding solution to implement. Here, for exemplary purposes, the description is noted to be a receipt of an error E when requesting X 525; and, the solution is noted to be Solution F 530. The Change Request 1 also may be associated with, among other items, a User ID of software support system representative ABC 505, a Tester ID of the tester MNO 510 of the Solution F 530. The table may also include the compatibility result “yes”. 515 (or “no” or a conditional result, for example) of the Solution F 530 with the Software Module ID 123X 520. In addition, the table may include an accessibility entry. The accessibility entry may be a security restriction which allows only certain users to implement the solution associated with Change Request 1. Or, an accessibility entry may be a flag for a subset table which is available to the user defined in the User ID or the Tester ID, to allow for easier lookup by a developer or tester. In this example, the access to Change Request 1 indicates no restrictions 535. The Change Request 2 600 is illustrated as associated with one User ID ABE 605, but two Testers MNO 610 and MNO 611. Each Tester is associated with its determined compatibility result of the solution with a specific software module. In this situation, Tester MNO 610 logged a “yes” compatibility result 615 concerning the solution 630 to solve the improvement need 625 of software module 456X 620. Tester MNO 611 instead logged a “no” compatibility result 616 concerning the same solution 630 for software module 789X 621. The table might also include information concerning the software modules 620 and 621 to indicate their relationship, if any. For example, there might be a description that they are versions of the same software product. When the Change Request 2 600 is employed by a user of software module 620 to implement the solution 630 the user may be prompted with a popup window or other screen view which may display all software modules 615: 616 which may or may not be implementable with the solution 630. Or, the interface may only list those software modules which are “yes” compatible with the solution. As an additional feature the patch or software program containing the solution may also contain a subprogram which accesses the user's system directory to determine whether the users system contains any or all of the software modules for example, software modules 456X 620 and 789X 621. And, based on that determination, the user interface may include in its display and selectable list all software modules which are both in the table for the change request, and in the user's system directory. This way, the user is not selecting updates of software modules it does not even have in its system. In FIG. 5; Change Request 2 600 also provides a security access restriction to user group G 635. This user group G 635 can include any number of persons or systems. For example, the user group G 635 may include a restriction that the change request is not implementable (or is implementable) automatically by the user's system without a user interface providing the user with an option to choose which software module(s) should be implemented with the solution.

The above embodiments are for exemplary purposes only and are not meant to limit the present invention. Further, the above embodiments may be used alone or in combination with each other.

What is claimed is:

1. A method of automatically tracking changes made to related software components, comprising:
creating a change to a system component;
determining any related system components;
applying the change to the system component and to any determined related system components; and
storing a record of the change, the system component, and any determined related system components, in a database.

2. The method of claim 1, further comprising testing the change to ensure compatibility with the system component and any determined related system components.

3. The method of claim 2, wherein the applying the change occurs only on the system component and any determined related system components deemed compatible with the change.

4. The method of claim 3, further comprising sending a change request package to another user of at least one of the system component and any determined related system component.

5. The method of claim 3, further comprising providing a user interface offering to apply the change to additional related system components; and upon acceptance of the offering executing the change to the additional related system components, wherein the addition related system components are obtained via a previously stored record in the database.

6. The method of claim 1, wherein the determining occurs by manual user input.

7. The method of claim 1, wherein the determining occurs via a preexisting lookup table.

8. The method of claim 1, wherein the applying occurs only to components which are selected by a user.

9. The method of claim 1, wherein the creating only occurs if the change has not previously been created and stored in the database.

10. A computer system, comprising:
an arrangement for determining related system components
an arrangement for applying said change to said system component and to said related system components; and
an arrangement for storing a record of said change and said related components in a database.

11. The computer system of claim 10, wherein the change is tested to ensure compatibility with the system component and related system components.

12. The computer system of claim 10, wherein the change is proposed to all other users of at least one of the same system component and a related system component.

13. The computer system of claim 10, further comprising a user interface identifying additional related system components, wherein the additional related system components are obtained from a previously stored record in the database.

14. A computer-readable storage medium storing a set of instructions, the set of instructions capable of causing a processor to implement a method comprising:
creating a change to a system component;
determining any related system components;
applying the change to the system component and to any determined related system components; and
storing a record of the change, the system component, and any determined related system components in a database.

15. The method of claim 14, further comprising testing the change to ensure compatibility with the system component and any determined related system components.

16. The method of claim 15, wherein the applying the change occurs only on the system component and any determined related system components deemed compatible with the change.

17. The method of claim 16, further comprising sending a change request package to all other users of at least one of the system component and any determined related system component,
wherein the determining occurs by at least one of manual user input and a preexisting lookup table.

18. The method of claim 14, wherein the applying occurs only to components which are selected by a user.

19. The method of claim 14, wherein the creating only occurs if the change has not previously been created and stored in the database.

20. The method of claim 14, further comprising providing a user interface offering to apply the change to additional related system components; and upon acceptance of the offering executing the change to the additional related system components, wherein the addition related system components are obtained via a previously stored record in the database.
